(19) United States
(12) Patent Application Publication
(10) Pub. No.: US 2017/0165148 A1
(43) Pub. Date: Jun. 15, 2017

(54) Float the ball

(71) Applicant: William J. Barclift, Panasoffkee, FL (US)

(72) Inventor: William J. Barclift, Panasoffkee, FL (US)

(21) Appl. No.: 14/963,539

(22) Filed: Dec. 9, 2015

(51) Int. Cl. A61H 5/00; A63F 9/00

(52) U.S. Cl. CPC A61H 5/00; A63F 9/00; A63F 2250/02; A61H 2205/024

(57) ABSTRACT

The subject matter disclosed herein relates to targeting young people to enjoy a fun activity while improving their eye power. The principals of the game include eye exercises based on previous procedures.

### TECHNICAL FIELD

This is a game that is targeting young people to enjoy a fun activity while improving their EYE POWER. The principles of the game indude eye exercises based on proven procedures from late 1800 to 1920 by Dr. William Bates. Dr Bates had an interest in the New. York School system due to a situation with the students. Many of the students were having problems of reading the writing on the blackboard. Dr Bates persuaded the school board to put the Snellen-Test in every school classroom. The teachers explained to the students about Dr. Bates suggestions as to how the Snellen-Test should be used. The students checked their eyes as they came into the classroom. While the students were at their desks they were glancing occasionally at the Snellen Test. They would make an effort to read letters on the Snellen-Test and after a short time many students were not complaining about seeing the writing on the black board. After a time a superintendant decided that the eye thing was ridicules. He ordered that the Snellen Tests were to be removed and after many months the students were showing the same signs that the students had before the Snellen Tests were put in the classrooms. The good news was that the school Superintendents made a decision to bring back the Snellen Tests and the students improved again. Dr. Bates did research targeting students of the New York School System and found students of eye strength based on the Snellen-Test that tested 20/15 were upper level students. Those students learned faster and excelled in many ways. This game is imbedded with a new discovery that gives the players a means of doing an alignment tune up of their eyes without even knowing it. If a student has eyes that are out of alignment he or she will have problems of (earning and not enjoy reading as other students with perfect alignment. Parents of these students with more knowledge about eyes than most people will take their child to the doctor and have a test that is probably done with a laser machine. The goal of this game is for every person using the game to have perfect eye alignment without a lot of know-how and cost. The players of this game will have a “FLOAT THE BALL” board with two balls with faces on them called Yaun and Rocky that have strange lips. Yaun has an upper lip and no lower lip. Rocky has a lower lip and no upper lip. When the player looks at Yaun and Rocky, they will change their focus to reading distance, and their peripheral vision will still see Yaun and Rocky that will become one together and float in the air happy with perfect lips. We call the fused floating ball with perfect upper and lower ups Ole Rock. The player that is seeing perfect fitted lips has proper alignment. Some players see the lips as Imperfect. They will naturally pause and look at the lips and a message will go to their brain as they slightly strain and the lips become perfect. They may have to do this over for a few times until their eyes are in alignment. As they play the game they will keep their eyes in alignment without fan fare. It is important for their eyes to be aligned for EYE POWER THAT BUILDS BRAIN POWER.

### BACKGROUND

The disclosed invention evolved due to my cataract surgery a few years back. I choose one lens for distant and the other for close vision. Reading turned out to be difficult and I tried many things and came across a book by Dr. William Bates about eye exercises and became convinced that eye mussels can be improved. I exercised my eyes with the help of a new internet sales advertisement that explained you could look at two drinking cups on a sheet of paper and cause them to float in the air and you could look at the top or the bottom view. The system was an improvement but my eyes were out of alignment and I began to try new things.

The next step occurred with an inspiration to do something to keep young people from having a tack of understanding about eye care. This invention is an embedded part of a fun game for young people and is vital to eye care. The invention will keep the players with proper eye alignment while having fun experiences playing the game of FLOAT THE BALL.

The discloser of the invention is in drawing FIG. 1. The graphics are displayed as a ball. Any graphic could be used with specific requirements. The balls have faces to be appealing to young people and the lips of the faces are used for the purpose of eye alignment. In above mentioned drawing FIG. 40 will be held at arm's length viewed for the purpose of floating the ball. Distance of arms length is only for the above mentioned game. Any length can be used. FIG. 50 is. the result of a player of the game changing their eye focus. The two parts of FIG. 40 are individually FIG. 10 and FIG. 20 that become fused as FIG. 50. The result is that the lips on FIG. 50 are aligned perfectly by matching the corners of the lips perfectly. If the lips do not fit perfectly they are out of alignment. The players of the game will pause andlook at the out of alignment lips and make slight eye strain to cause the lips to fit perfectly. They may over time have to do this until they are in perfect alignment

### BRIEF DESCRIPTION OF DRAWINGS

FIG. 1, A GRAPHIC OBJECT 40 OF ANY SHAPE WITH TWO PARTS 10 OR 20 SEPARATED ON A HORIZONTAL PLAIN WITH A SEPARATED 40.

FIG. 2, CAMERA OR ANY OTHER DEVICE 50 THAT CAN CAPTURE IMAGES TO FLOAT AN IMAGE FOR THE PURPOSE OF ALIGNMENT.

FIG. 3, AN AUTO HAVING TWO STABLE VERTICAL GRAPHICS 10 OR 20 ON A HORIZONAL LINE SEPARATED BY A DISTANCE WHILE 10 IS NORTH AND 20 IS SOUTH.

### DETAILED DESCRIPTION

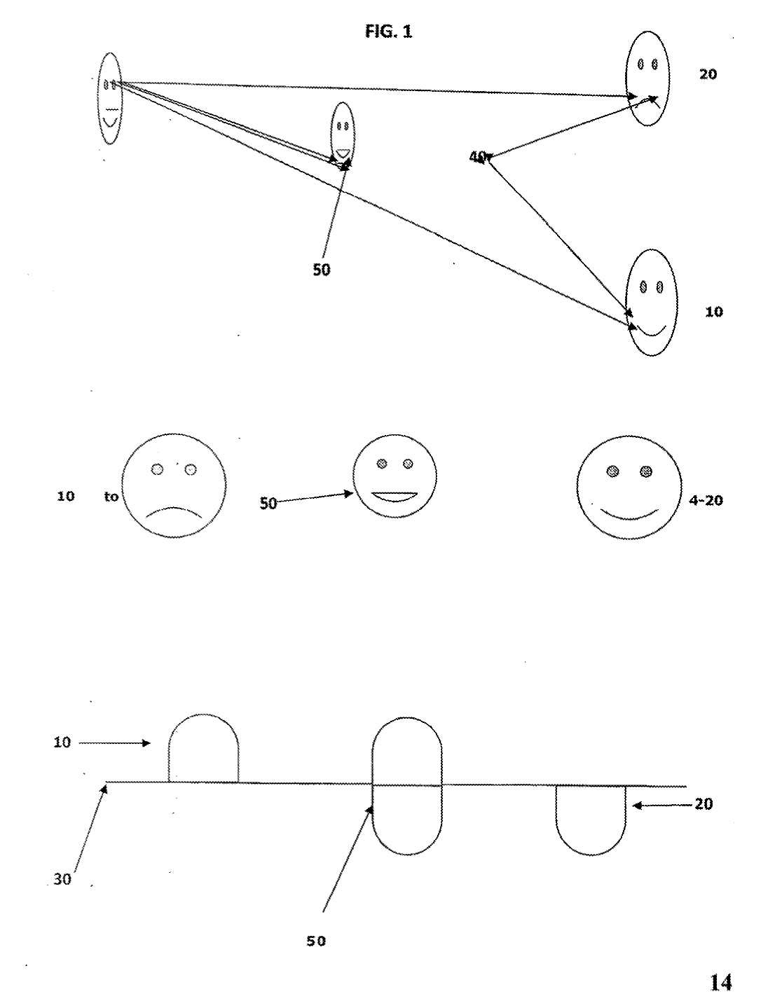

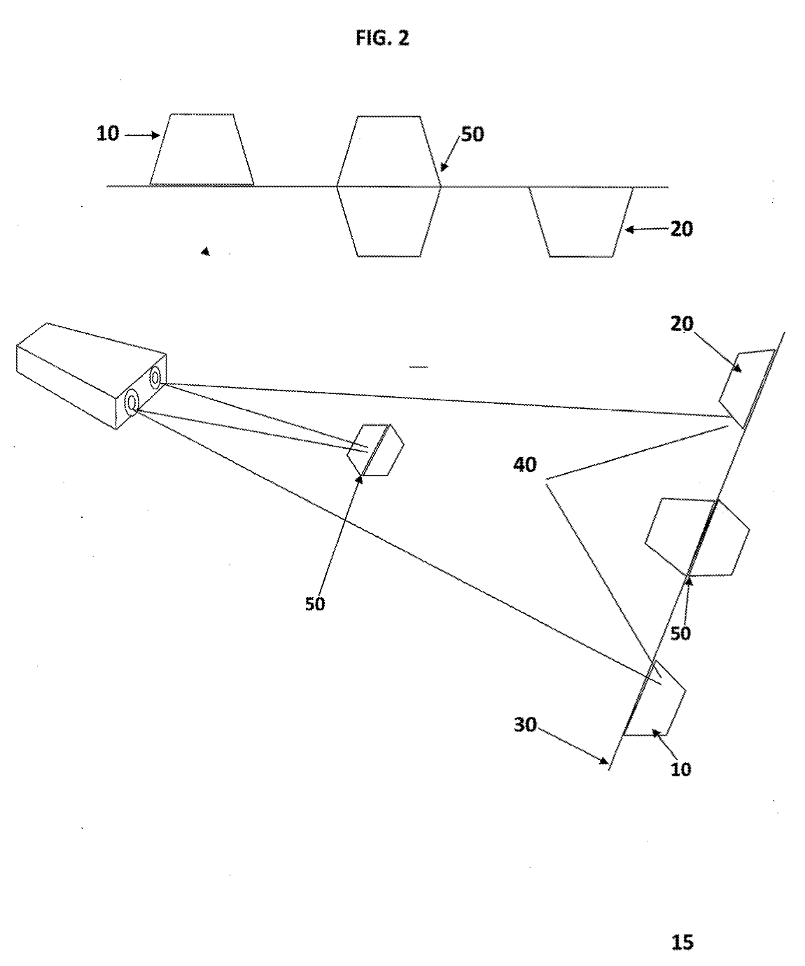

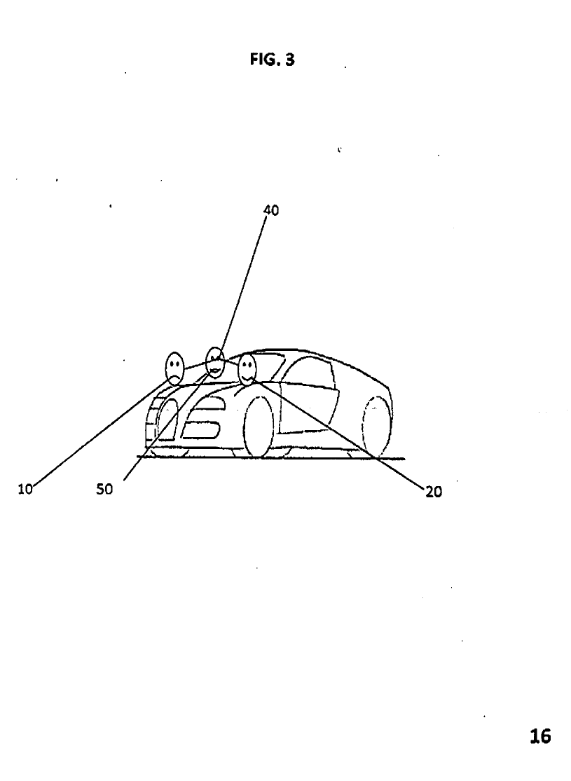

There are three drawings with (10, 20,30, 40, and 50) that Explain how eye alignment works. (Drawings FIG. 1) explains how eye alignment works with human eyes. (Drawings FIG. 2)-explains visual alignment for cameras. (Drawings FIG. 3) explains how it is possible to use the principle in (Drawings FIG. 1) with different methods for the accomplishment of visual alignment for self driving vehicles. The player of the game learns a simple procedure of Float the Ball. The players use A “FLOAT THE BALL BOARD” (FTB) that is letter size 8½ by 11 and 15/8 thick for the purpose of floating the ball. There are two balls on the front of the FTB with two different faces. Their names are Yuan and Rocky. Disclosure of the imbedded new way for eye alignment is on Yuan and Rockies Face. Yuan is missing his lower lip and Rocky Is missing his upper Lip. The players look at Yuan and Rocky on their FTB and shift their focus to reading distance and a third ball floats in the air called Ole Rock. Ole Rock now has lips that are proven to be in Perfect alignment.

### SUMMARY

Disclokd is a new way to know if your eyes are out of alignment. This discovery is Imbedded in a game of fun that will strengthen the player's eye muscles and if Their eyes are out of alignment they will be able to easily correct the problem As they play the game. There are three drawings with (10, 20, 30, 40, and 50) that Expain how eye alignment works. (Drawings FIG. 1) explains how eye alignment works with human eyes. (Drawings FIG. 2) explains visual alignment for cameras. (Drawings FIG. 3) explains how it is possible to use the principle in (Drawings FIG. 1) with different methods for the accomplishment of visual alignment for self driving vehicles. The player of the game learns a simple procedure of Float the Ball. The players use A “FLOAT THE BALL BOARD” (FIB) that is letter size 8½ by 11 and 15/8 thick for the purpose of floating the ball. There are two balls on the front of the FTB with two different faces. Their names are Yuan and Rocky. Disclosure of the imbedded new way for eye alignment is on Yuan and Rockies Face. Yuan is missing his lower lip and Rocky Is missing his upper lip. The players look at Yuan and Rocky on their FTB and shift their focus to reading distance and a third ball floats in the air called Ole Rock. Ole Rock now has lips that are proven to be In Perfect alignment.

As shown in FIG.1, a graphic object (40) of any shape with two parts (10 or 20) separated on a horizontal plain with a Separation (10 and 20) must have identical vertical extremes. The (10 or 20) graphics can connect their Flat side above or Below a Horizontal line (30) for the purpose of setting up an arrangement to float the Ball. Human eyes can look at (10, 20) from a distance as above mentioned “graphic object” (40). While gazing at (40); human eyes can change their focus to a closer distance and cause (10 and 20) to fuse and become one (50). The choice of Lips (50) can be of unlimited shapes that could be utilized. When (50) Occurs; It should be a perfect fit of the upper and lower lips. When the vertical extremes of the Lips (50) exactly match you have proved that you have perfect eye alignment. The above mentioned Methodology could be useful for synchronization of any form that requires vision alignment.

The individual graphics (10, 20) are placed on a horizontal line according to a 90 degree direction of a visual machine. (10 or 20) are on top of the line (30) and (10 or 20) are on the bottom of (30) at a determined distance.

In order to align cameras and visual machines it is necessary to gaze on (10 and 20) and change focus to a nearer focus. This is where human and artificial eyes part. The image (50) would only be seen by the camera or visual machine. The interception of (50) would have to be imbedded with some means of laser, digital, or other means.

FIG. 2 Cameras or any devices that can capture images can have the ability to float an image for the purpose of alignment and if they are paired in lockstep fashion? One camera with two built in devices that can capture Images similar to the operation of human eyes could be more effective. If the previous mentioned devices have the capability of rapid change focus ability they should be successful in keeping their. Devices in alignment. Please refer to drawings in Fig.1 for basic explanations and similarities. You will find the same numbers on drawings FIG. 1 as drawing FIG. 2 in order to illustrate the similarity.

The alignment for machine vision could be similar to human vision. The Human brain competition is Making exciting work times for our engineers. Engineers are making progress as each day goes by, in The pursuit of methods that accomplishes similar tasks as human brains accomplish. In the Very near future vehicles will be on our highways operating without human control. The vision Component is vital. The principle of human eye alignment can be utilized in many ways. Constant Monitoring and vision correction will add assurance to the passengers that will be utilizing the advanced Vehicles. The methodology explained in FIG. 1 can be used with digital, laser, or any means to use vision Seeing two stable vertical graphics (10 or 20) on a horizontal line (30) separated by a distance while (10) Is North and (20) is South. The width of the graphic or object has to be exactly the same at the part that Touches the horizontal Line (30). The numbers in FIGS. 2 and 3 are the same as drawings in FIG. 1 in order To see the similarities. Notice that 10 and 20 are mounted on the car. The reason for the mounting is That continuous alignment operation needs a stable horizontal foundation.

There are many changes in the auto industry. Self driving vehicles are becoming the next big change in that industry. The visual systems have made monumental steps to become similar to human vision. The method of visional alignment illustrated in the subject invention could be adapted to many visual systems. The principal of the invention would be economically advantageous to this industry.

### Man Made Vision

As shown in FIG. 3 two objects mounted on a vehicle shaped as graphics (10 and 20) could be used in the auto industry. The visual system could focus on the objects (10, 20) and change focus to near while receiving image or other to determine if lips (50) are perfect.

There are many changes in the auto industry. Self driving vehicles are becoming the next big change in that industry. The visual systems have made monumental steps to become similar to human vision. The method of visional alignment illustrated in the subject invention could be adapted to many visual systems. The principal of the invention would be economically advantageous to this industry.

### Man Made Vision

As shown in FIG. 3 two objects mounted on a vehicle shaped as graphics (10 and 20) could be used in the auto industry. The visual system could focus on the objects (10, 20) and change focus to near while receiving image or other to determine it ups (50) are perfect.

1. Create a fiat surfaced vertical object with two graphics (10, 20) spaced similar to normal eyes and positioned on a horizontal plain move the above mentioned objects away from your eyes a comfortable distance that will allow you to see the graphics perfectly the graphics on the above mentioned object must be exactly the same at the horizontal width each graphic (10, 20) must have a straight edge (30) at their bottom touching above or below the horizontal line imagine an object (50) sitting on a mirror and viewing one object (10 or 20) upright and the other object (10 or20) upside down You are seeing two objects (50) perfectly matched. Now move the bottom object to the right a normal eye separation or you can reverse the procedure you are now looking at the two graphics (10, 20) you are seeing one graphic on the top of the horizontal line (30) the other graphic is on the bottom of the horizontal line (30) now you are going to look at above mentioned graphics (10, 20) and float them into a fused image look at the two graphics (10, 20) and change your eye focus from distant to reading if this is first time experience you may need to put your thumb about your nose level and move your thumb to your reading distance and look over your thumb to the distant graphics (10, 20) and shift your focus to the tip of your thumb the fused image will be floating closer to you and you will see a perfect match (50) or not a perfect match a perfect match is perfect eye alignment this game of eye power can help the eye alignment by users that are not a perfect match (50) due to playing the game each time they float the graphic they will see that they are out of alignment and normally do a slight eye strain causing their brain to act and a perfect alignment will come.
